(19) United States
(12) Patent Application Publication
(10) Pub. No.: US 2015/0068058 A1
(43) Pub. Date: Mar. 12, 2015

(54) METHOD FOR UTILIZING SPENT GRAIN IN A BREWERY AND CORRESPONDING DEVICE

(71) Applicant: SIEMENS AKTIENGESELLSCHAFT, Munich (DE)

(72) Inventors: Andreas Buettner, Stolzenberger Hof (DE); Thomas Hammer, Hemhofen (DE); Martin Tackenberg, Forchheim (DE); Gernut Van Laak, Nuremberg (DE)

(73) Assignee: SIEMENS AKTIENGESELLSCHAFT, Munich (DE)

(21) Appl. No.: 14/379,936

(22) PCT Filed: Jan. 29, 2013
(86) PCT No.: PCT/EP2013/051667

§ 371 Date: Aug. 20, 2014

(30) Foreign Application Priority Data
Feb. 20, 2012 (DE) 10 2012 202 532.4

(51) Int. Cl. F26B 5/14; C12F 3/10

(52) U.S. Cl. CPC F26B 5/14; C12F 3/10
USPC 34/398; 34/90

(57) ABSTRACT

A method for utilizing spent grain in a brewery in which the spent grains are mechanically dewatered and then thermally utilized. The press water arising from the mechanical dewatering is thermally concentrated using low-temperature waste heat generated during the brewing process.

### CROSS REFERENCE TO RELATED APPLICATIONS

This application is based on and hereby claims priority to International Application No. PCT/EP2013/051667 filed on Jan. 29, 2013 and German Application No. 10 2012 202 532.4 filed on Feb. 20, 2012, the contents of which are hereby incorporated by reference.

### BACKGROUND

The invention relates to a method for utilizing spent grain in a brewery, in which the spent grain is dewatered mechanically.

Modern breweries in which measures have already been taken to reduce the consumption of energy and water have a water consumption of 3.5 to 5 hl per hectoliter of beer produced and a thermal-energy requirement of approximately 25 kilowatt hours per hl of beer. The thermal-energy requirement is normally covered by fossil fuels, by the operation of a steam generator for generating process steam at a temperature of typically 180° C. The waste water which is produced during the brewing process has to be subjected to cleaning prior to being introduced into the sewerage system, since some of the waste water has an oxygen requirement which is not compatible with cleaning in a conventional sewerage-treatment plant. In addition, each hectoliter of beer produced is accompanied by at least 16.5 kg spent grain with a water content of around 80%, which has to be disposed of or utilized. Utilization as an additive in animal feed is possible only to a limited extent and is becoming less and less a matter of accepted practice.

WO98/22751 proposes a method for thermally utilizing spent grain from beer. Provision is made here for wet spent grain from beer to be pre-dried mechanically in a drying stage, to be dried thermally in a further drying stage and, finally, to be utilized thermally by combustion or gasification. The operation of mechanically pre-drying the spent grain beer should result in a water content preferably of at least 65%, of further preferably down to at least 62%. The amount of energy necessary for the pre-dying operation comes from the waste-gas heat from a steam generator. The press water from the spent grain should preferably be fermented anaerobically, in order for biogas to be recovered therefrom.

The problem here, however, is that the waste water from the anaerobic fermentation process cannot be introduced into a normal waste-water system. For quality-related reasons, it is also not an option for the press water from the spent grain to be utilized by being channeled back into the brewing process.

### SUMMARY

It is therefore one possible object to specify a method for utilizing spent grain which is advantageous from the point of view of energy and reduces the loading to which the waste water is subject by organic residues and mineral substances.

The inventors propose a method the type mentioned in the introduction, for press water, which is produced during the mechanical dewatering operation, to be concentrated thermally by the use of low-temperature waste heat which occurs during the brewing process.

The method is based on the finding that spent grain can be better utilized by being dewatered to the extent where it can then be used thermally, for example by combustion in the steam generator. The press water, which occurs mechanical dewatering operation, is subjected to thermal concentration and can then be treated further, and this therefore reduces the loading to which the waste water and downstream sewerage-treatment plants are subjected.

In the case of the method, it is preferred if the spent grain is concentrated to a water content of below 50%, preferably below 45%, in order to allow thermal utilization by combustion. In contrast to conventional methods, the spent grain has so much water extracted from it that the spent grain which remains can be combusted directly. The spent grain is preferably dewatered by a belt press. It also resides within the frame work of the method that the press water is evaporated in a preferably circulating airstream and is recovered in the form of clean product water in a condenser.

The heat released in the condenser can be used here for the purpose of pre-heating the press water which is to be treated, as a result of which a significant fraction of the heat fed for evaporation purposes is recovered. The operation of producing the clean product water from the press water from the spent grain can thus be carried out in a particularly energy-efficient manner.

A development of the method provides for the clean product water then to be used for bottle-cleaning purposes. This makes it possible to avoid the use of fresh drinking water for this purpose.

In order to reduce the loading to which the waste water is subjected, provision may be made, in the case of the method, for at least some of the concentrated press water to be added to the spent grain. As an alternative, or an addition, the concentrate press water can be channeled back in a circuit for thermal water treatment. The concentrated press water can be added, for example, to the separated off, not-yet-pressed spent grain; the excess of water produced thereby does not have any effect, during the pressing operation, on the end content of the water in the spent grain once pressed. The press water recovered has, at most, a slightly increased content of organic substances and mineral substances, but the filter action of the spent grain then places this content below the average of fresh and concentrated press water.

If the concentrated press water, as an alternative, or in addition, to the thermal water treatment, is channeled back, it can be directed beforehand through a settling tank or a filtration stage in order for the concentration of suspended matter to be reduced.

According to the proposal, the waste heat for the thermal concentration of the press water can be taken from one of the following sources: a condensate-return section of steam circuit, the waste gas from the burner for a steam generator, a wort-cooling device or a bottle-washing machine.

In a further configuration of the method, provision may be made for the press water, which is produced during the operation of dewatering the spent grain, to be fermented anaerobically and for the waste water from the fermentation process to be concentrated thermally.

The inventors also propose an apparatus for utilizing spent grain. The apparatus is distinguished in that it is designed for implementing the method described.

### BRIEF DESCRIPTION OF THE DRAWINGS

These and other objects and advantages of the present invention will become more apparent and more readily appreciated from the following description of the preferred embodiments, taken in conjunction with the accompanying drawings of which:

FIG. 1 shows an apparatus for implementing the proposed method;

FIG. 2 shows a detail of a variant of the proposed apparatus;

FIG. 3 shows a further detail of a variant of the proposed apparatus;

FIG. 4 shows a further detail of a variant of the proposed apparatus; and

FIG. 5 shows a further detail of a variant of the proposed apparatus.

### DETAILED DESCRIPTION OF THE PREFERRED EMBODIMENT

Reference will now be made in detail to the preferred embodiments of the present invention, examples of which are illustrated in the accompanying drawings, wherein like reference numerals refer to like elements throughout.

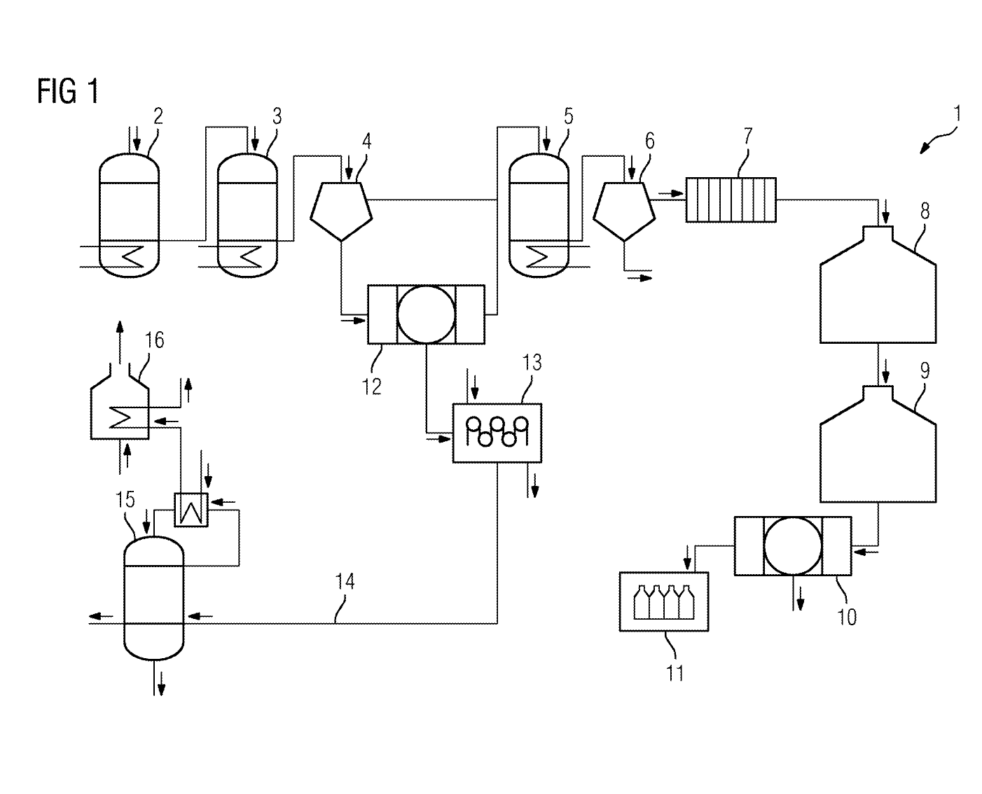

FIG. 1 shows an apparatus 1 for treating spent grain in a brewery. The apparatus comprises a mash tun 2, a mash kettle 3, a lauter tun 4 and a brewing kettle 5. The liquid is then subjected to a clarification treatment 6, cooled in a cooling apparatus 7 and passes into a fermentation tank 8. From there, the product passes into a tun 9, and then is channeled through a filter 10, followed by a filling station 11. To this extent, the apparatus 1 corresponds to a conventional apparatus in a brewery.

Passage through the lauter ton 4 results in spent grain 12 with a high water content. The spent grain 12 is pressed, by a belt press 13, until it has a water content of less than 45%. The press water from the spent grain passes, via a line 14, into a water-treatment installation 15, which contains at least one evaporator and at least one condenser and in which the press water is subjected to thermal separation. The heat which is necessary for this purpose is taken, by a heat exchanger 20, for example from a condensate-return section of the steam circuit which is present in the brewery for supplying the process heat, before being fed back to the steam generator 16 and heated, and evaporated, by a fed fuel.

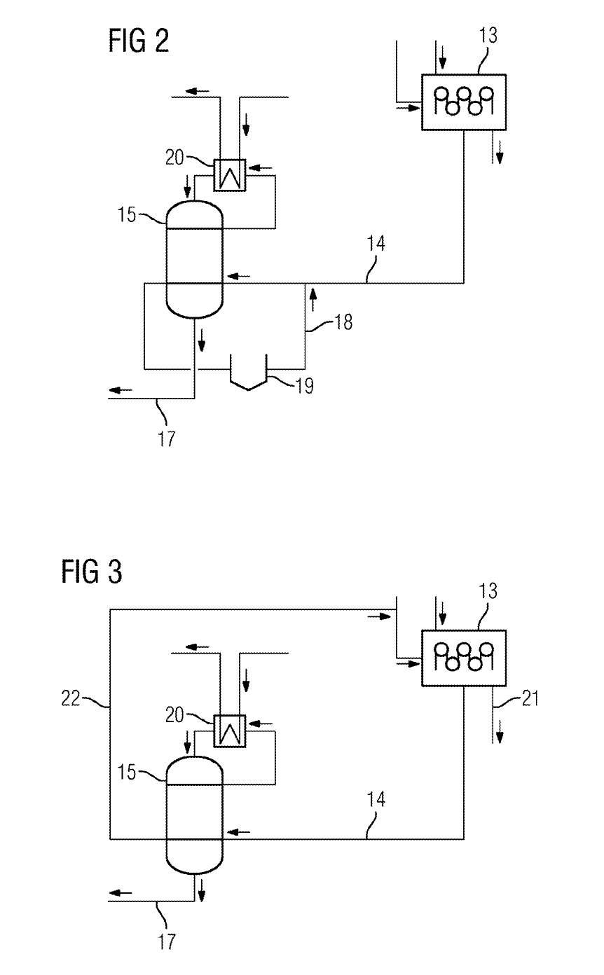

FIG. 2 shows a detail of a further exemplary embodiment of an apparatus for utilizing spent grain in a brewery. The press water from the spent grain is dewatered in a belt press 13 and passes, via the line 14, to the water-treatment installation 15. A significant fraction of the concentrated press water is recovered in the form of clean product water 17. The concentrate water 18 is taken in from the water-treatment installation 15 and fed to a settling tank 19, where suspended matter can settle before being fed, via a return line, to the supply line 14 for the press water.

The water-treatment installation 15 is additionally coupled to a heat exchanger 20, which is fed with waste heat which occurs in another process in the brewery.

FIG. 3 shows a detail of a further exemplary embodiment of an apparatus for utilizing spent grain.

Following passage through the belt press 13, the dewatered spent grain 21 can be used thermally, for example by combustion in a steam generator designed specifically for this purpose.

The press water passes through the water-treatment installation 15 via the line 14. FIG. 3 illustrated that concentrated press water is channeled from the water-treatment installation 15, via a line 22, back to the entrance for spent-grain treatment and thus to the belt press 13. As in the preceding exemplary embodiment, the water-treatment installation 15 is connected to heat exchanger 20, and therefore the press water is concentrated thermally and then obtained in the form of product water 17.

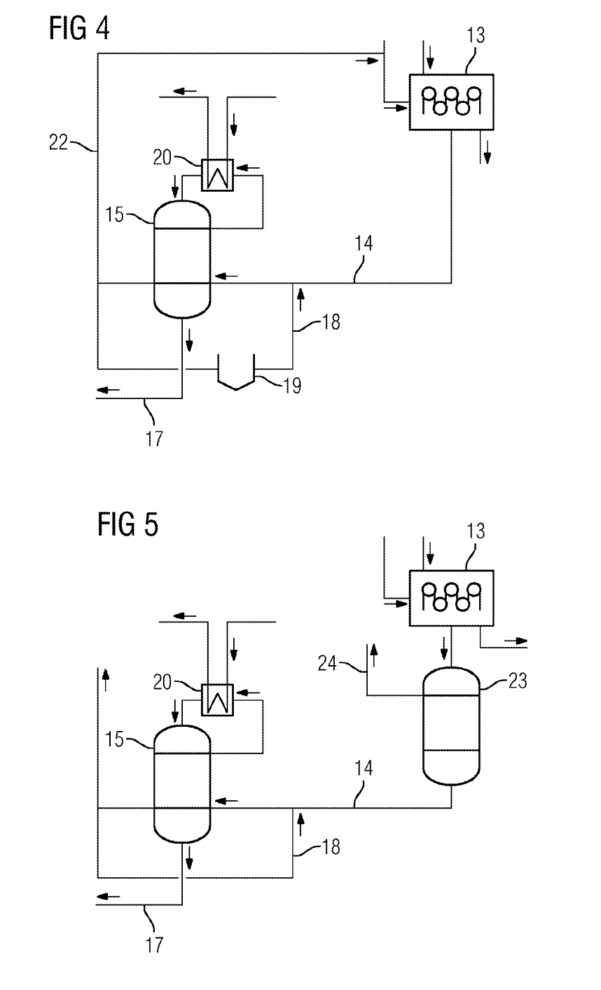

FIG. 4 shows a detail of a further exemplary embodiment of an apparatus for utilizing spent grain, this exemplary embodiment essentially being a combination of the variants shown in FIGS. 2 and 3. Following passage through the mechanical drying stage, e.g. a belt press 13, press water passes, via the line 14, to the water-treatment installation 15, which is connected to the heat exchanger 20. From the water-treatment installation 15, the line 22 leads back to the entrance for spent-grain drying, e.g. the belt press 13. Additionally provided is a return line 18, in which the settling tank 19 is located. The press water is thus channeled back, on the one hand, to the entrance for spent-grain drying and, on the other hand, to the entrance for press-water treatment.

FIG. 5 shows a further exemplary embodiment of an apparatus for utilizing spent grain, this apparatus comprising, in correspondence with the preceding exemplary embodiments, a mechanical drying stage and a water-treatment installation 15. A fermentation reactor 23 is located downstream of the mechanical drying stage, and the press water is fermented anaerobically therein. This fermentation process results in biogas 24, which can be used for example as fuel. Following passage through the fermentation reactor 23, the fermented press water passes to the water-treatment installation 15, in which clean product water 17 is recovered therefrom. The fermented press water is channeled back, via the return line, into the water-treatment installation 15 and concentrated in stepwise fashion. The water-treatment installation 15, as in the preceding exemplary embodiments, is connected to the heat exchanger 20.

The invention has been described in detail with particular reference to preferred embodiments thereof and examples, but it will be understood that variations and modifications can be effected within the spirit and scope of the invention covered by the claims which may include the phrase “at least one of A, B and C” as an alternative expression that means one or more of A, B and C may be used, contrary to the holding in Superguide v. DIRECTV, 69 USPQ2d 1865 (Fed. Cir. 2004).

1-11. (canceled)

12. A method for utilizing spent grain in a brewery, comprising:
mechanically dewatering the spent grain to produce press water; and
thermally concentrating the press water using low-temperature waste heat which occurs during a brewing process.

13. The method as claimed in claim 12, wherein the spent grain is dewatered to a water content of below 50% to allow thermal utilization by combustion.

14. The method as claimed in claim 12, wherein the spent grain is dewatered to a water content of below 45% to allow thermal utilization by combustion.

15. The method as claimed in claim 12, wherein the spent grain is dewatered by a mechanical drying state in the form of a belt press.

16. The method as claimed in claim 12, wherein the press water is evaporated in a circulating air stream and then recovered as clean product water in a condenser.

17. The method as claimed in claim 16, wherein the press water is pre-heated before evaporation by heat released in the condenser.

18. The method as claimed in claim 16, wherein the clean product water is used for bottle-cleaning purposes.

19. The method as claimed in claim 12, wherein
concentrating the press water produces concentrated press water, and
at least some of the concentrated press water is added to the spent grain before the spent grain is mechanically dewatered.

20. The method as claimed in claim 12, wherein
concentrating the press water is performed in a treatment installation and produces concentrated press water, and
at least some of the concentrated press water is channeled back to the treatment installation in a circuit.

21. The method as claimed in claim 12, wherein the waste heat for thermally concentrating the press water is taken from at least one source selected from the group consisting of: a condensate-return section of a steam circuit, waste gas of a burner for steam generation, a wort-cooling device, and a bottle-washing machine.

22. The method as claimed in claim 12, wherein
the press water, which is produced by mechanically dewatering the spent grain, is fermented anaerobically in a fermentation process that produces waste water, and
the waste water from the fermentation process is concentrated thermally.

23. An apparatus for utilizing spent grain, comprising:
a mechanical dewatering device to mechanically dewater the spent grain to produce press water; and
a thermal concentrator to thermally concentrate the press water using low-temperature waste heat which occurs during a brewing process.

24. The apparatus as claimed in claim 23, wherein
the mechanical dewatering device is a belt press, and
the thermal concentrator comprises a condenser to produce clean water.
